(19) United States
(12) Patent Application Publication
(10) Pub. No.: US 2025/0005384 A1
(43) Pub. Date: Jan. 2, 2025

(54) SYSTEMS AND METHODS FOR KNOWLEDGE GRAPH ENRICHMENT USING UNSTRUCTURED DATA

(71) Applicant: JPMORGAN CHASE BANK, N.A., New York, NY (US)

(72) Inventors: Jainesh DOSHI, San Francisco, CA (US); Anagha RUMADE, Mountain View, CA (US); Sadra AMIRI MOGHADAM, Mission San Jose, CA (US); Abhik BANERJEE, Milpitas, CA (US); Mani KEERAN, Danville, CA (US)

(21) Appl. No.: 18/343,348

(22) Filed: Jun. 28, 2023

(51) Int. Cl. G06N 5/022

(52) U.S. Cl. CPC G06N 5/022

(57) ABSTRACT

In some aspects, the techniques described herein relate to a method performed by a graph enrichment platform, including: receiving an unstructured data object; extracting a fact from the data object, in the form of a subject, a predicate and an object; generating a first new node, a second new node, and a first new edge from the data object; assigning properties to the first new node, the second new node, and the first new edge; predicting a second new edge, wherein the second new edge connects one of the first new node or the second new node to an existing node in the knowledge graph; preparing a graph update, wherein the graph update includes the first new node, the second new node, the first new edge, and the second new edge; performing a conflict check on the graph update; and pushing the graph update to the knowledge graph.

### BACKGROUND

### 1. Field of the Invention

Aspects generally relate to systems and methods for knowledge graph enrichment using unstructured data.

### 2. Description of the Related Art

Modern organizations collect large amounts of unstructured data from multiple internal and external data sources. Such information may include public firmographic information of various businesses and individuals and internal information related to partner businesses produced by an organization and the organization's data processing systems. Such data can be stored in a knowledge graph that captures the multitude of relationships between the numerous entities that an organization may be interested in understanding. Knowledge graphs provide efficient methods for querying and understanding large amounts of interrelated data.

Contemporary knowledge graphs are built by loading data from structured sources. Generally, updates are carried out via periodic batch operations. Transforming unstructured data into a structured format that may be ingested by a knowledge graph update routine, however, is time-consuming and requires manual supervision. Automated aggregation and analysis to generate new information, and ingestion of such information, however, has proven challenging. As has dynamically altering a graph's ontology and enriching a graph using an updated ontology with discovered facts in real time in order to keep the knowledge graph evergreen.

### SUMMARY

In some aspects, the techniques described herein relate to a method including: receiving unstructured data; persisting the unstructured data as a data object; extracting a fact from the data object, wherein the fact includes a plurality of components, and wherein the plurality of components include a subject, a predicate and an object; determining one or more of the plurality of components is not present in a knowledge graph; generating a first new node, a second new node, and a first new edge from the one or more of the plurality of components not present in the knowledge graph, assigning properties to the first new node, the second new node, and the first new edge; predicting a second new edge, wherein the second new edge connects one of the first new node or the second new node to an existing node in the knowledge graph; preparing a graph update, wherein the graph update includes the first new node, the second new node, the first new edge, and the second new edge; performing a conflict check on the graph update; and pushing the graph update to the knowledge graph.

In some aspects, the techniques described herein relate to a method, wherein the first new node is generated from the subject, the second new node is generated from the object, and the first new edge is generated from the predicate.

In some aspects, the techniques described herein relate to a method, wherein the first new edge connects that first new node and the second new node.

In some aspects, the techniques described herein relate to a method, wherein the properties are from a registered property repository.

In some aspects, the techniques described herein relate to a method, wherein the unstructured data is received as a data stream from an event streaming platform.

In some aspects, the techniques described herein relate to a method, wherein the knowledge graph is a labelled property graph.

In some aspects, the techniques described herein relate to a method, wherein the knowledge graph is a Resource Description Framework (RDF) graph.

In some aspects, the techniques described herein relate to a system including at least one computer including a processor and a memory, wherein the at least one computer is configured to: receive unstructured data; persist the unstructured data as a data object; extract a fact from the data object, wherein the fact includes a plurality of components, and wherein the plurality of components include a subject, a predicate and an object; determine one or more of the plurality of components is not present in a knowledge graph; generate a first new node, a second new node, and a first new edge from the one or more of the plurality of components not present in the knowledge graph, assign properties to the first new node, the second new node, and the first new edge; predict a second new edge, wherein the second new edge connects one of the first new node or the second new node to an existing node in the knowledge graph; prepare a graph update, wherein the graph update includes the first new node, the second new node, the first new edge, and the second new edge; perform a conflict check on the graph update; and push the graph update to the knowledge graph.

In some aspects, the techniques described herein relate to a system, wherein the first new node is generated from the subject, the second new node is generated from the object, and the first new edge is generated from the predicate.

In some aspects, the techniques described herein relate to a system, wherein the first new edge connects that first new node and the second new node.

In some aspects, the techniques described herein relate to a system, wherein the properties are from a registered property repository.

In some aspects, the techniques described herein relate to a system, wherein the unstructured data is received as a data stream from an event streaming platform.

In some aspects, the techniques described herein relate to a system, wherein the knowledge graph is a labelled property graph.

In some aspects, the techniques described herein relate to a system, wherein the knowledge graph is a Resource Description Framework (RDF) graph.

In some aspects, the techniques described herein relate to a non-transitory computer readable storage medium, including instructions stored thereon, which instructions, when read and executed by one or more computer processors, cause the one or more computer processors to perform steps including: receiving unstructured data; persisting the unstructured data as a data object; extracting a fact from the data object, wherein the fact includes a plurality of components, and wherein the plurality of components include a subject, a predicate and an object; determining one or more of the plurality of components is not present in a knowledge graph; generating a first new node, a second new node, and a first new edge from the one or more of the plurality of components not present in the knowledge graph, assigning properties to the first new node, the second new node, and the first new edge; predicting a second new edge, wherein the second new edge connects one of the first new node or the second new node to an existing node in the knowledge graph; preparing a graph update, wherein the graph update includes the first new node, the second new node, the first new edge, and the second new edge; performing a conflict check on the graph update; and pushing the graph update to the knowledge graph.

In some aspects, the techniques described herein relate to a non-transitory computer readable storage medium, wherein the first new node is generated from the subject, the second new node is generated from the object, and the first new edge is generated from the predicate.

In some aspects, the techniques described herein relate to a non-transitory computer readable storage medium, wherein the first new edge connects that first new node and the second new node.

In some aspects, the techniques described herein relate to a non-transitory computer readable storage medium, wherein the properties are from a registered property repository.

In some aspects, the techniques described herein relate to a non-transitory computer readable storage medium, wherein the unstructured data is received as a data stream from an event streaming platform.

In some aspects, the techniques described herein relate to a non-transitory computer readable storage medium, wherein the knowledge graph is a labelled property graph.

### BRIEF DESCRIPTION OF THE DRAWINGS

FIG. 1 is a system for knowledge graph enrichment using unstructured data, in accordance with aspects.

FIG. 2 is a logical flow for knowledge graph enrichment using unstructured data, in accordance with aspects.

FIG. 3 is a block diagram of a computing device for implementing certain aspects of the present disclosure.

### DETAILED DESCRIPTION

Aspects generally relate to systems and methods for knowledge graph enrichment using unstructured data.

In accordance with aspects, systems and methods described herein may extract facts from unstructured data, determine a graph structure that accommodates the extracted facts, and enrich a graph including using facts extracted in real or near-real time from unstructured data received from various data sources. Aspects may facilitate processing multiple streams of data from various data sources, where the data streams include unstructured textual data objects. Data streams may originate from sources internal or external to an organization. Data streams may include such exemplary sources and objects as news content being published by external vendors, social media posts of individuals and corporate and juristic entities, and internal documents generated within an organization for a diverse set of reasons. Aspects may use entity recognition techniques to capture relevant entities from the data and differentiate them across similar ones using entity disambiguation methods.

Aspects may further classify relationships identified between entities determined from received data objects and determined classifications may also be used to update a knowledge graph. Aspects may identify new entities not yet captured in a graph and insert them into a graph with the corresponding relationships. A repository of possible features for nodes and edges existing on a current graph may be established from previous iterations and may be updated on an ongoing basis as new features are determined.

In accordance with aspects, a graph enrichment platform may receive unstructured data from a multitude of sources. Unstructured data includes information that is not formatted according to a pre-defined data model, or a fixed format. Often, unstructured data includes large amounts or text, text strings, characters, etc. Unstructured data may contain dates, numbers, and other numerical information, but numbers may be formatted as characters instead of numerical data types such as integers, floats, doubles, etc., which can have mathematical operations performed thereon. Exemplary unstructured file formats include web pages, word processor documents, portable document format (PDF) documents, and the like. Unstructured data may be considered qualitative data. Generally, unstructured data is not compatible with conventional data processing and analysis methods and tools due to its lack of formatting for any particular programmatic purpose.

In accordance with aspects, unstructured data sources include various external and internal data streams and feeds. Exemplary data sources include really simple syndication (RSS) feeds, social media posts, news applications, various business production applications, and data from repositories of unstructured data such as web servers, directory structures, and various other sources from inside and outside an organization.

An organization's business production applications may provide sources of unstructured data as well. Production business applications may provide unstructured data in the form of a data stream. For instance, a financial services organization may provide a transaction processing application or a payment processing application, and such an application may stream unstructured transaction or payment data via, e.g., an event streaming platform in real or near-real time (i.e., as a transaction or payment is processed). Exemplary unstructured data from business applications may include associated organization names, transaction details, payment details, amounts, asset trades, market data, and any other unstructured data that may be used to update a knowledge graph and graph ontology via the techniques described herein.

As used herein, a data stream is any transmission of data from a source system or application to a destination system or application. In some aspects, a data stream may be managed by an event streaming platform (also known as a distributed event streaming platform). A distributed event streaming platform (e.g., Apache Kafka®) may be configured for handling of real time and near-real time streaming data to/from streaming data pipelines and/or streaming applications. Streaming data may be continuously generated by a data source. An event streaming platform can receive streaming data from multiple sources and process the data sequentially and incrementally. Event streaming platforms can be used in conjunction with real time and near-real time streaming data pipelines and streaming applications. For example, an event streaming platform can ingest and store streaming data from a data pipeline or streaming application and provide the data to an application that processes the streaming data. An event streaming platform may include partitioned commit logs (each, an ordered sequence of records) to store corresponding streams of records. The logs are divided into partitions, and a subscriber can subscribe to a “topic” that is associated with a partition, and thereby receive all records stored at the partition (e.g., as passed to the subscriber in real time by the platform).

An event streaming platform may expose a producer API that publishes a stream of records from a streaming application or data pipeline to a topic, and a consumer API that a consumer application can use to subscribe to topics and thereby receive the record stream associated with that topic. An event streaming platform may also publish other APIs with necessary or desired functionality.

Unstructured data may be collected or streamed into a platform and may be processed by a data aggregator. A data aggregator may receive all incoming data streams, may prepare the data with preprocessing steps and may forward the received data to a property extraction engine. Data aggregation may be a bookkeeping step that is performed as a post-data collection step. A data aggregator may further be in operative communication with an aggregation data store where the data aggregator may persist incoming data. An aggregation data store may be any suitable data store (e.g., a relational database, a NoSQL database, etc.). In some aspects, an aggregation data store may be may be configured as a data lake. A data lake is a data store that can rapidly ingest large amounts of raw data (i.e., data that has not been processed or prepared for any particular use) as data objects in a native format. Accordingly, a data lake may rapidly persist large amounts of unstructured data received from multiple data sources without altering the data's native format.

In accordance with aspects, a data aggregator may send received data to an extraction engine. An extraction engine may use natural language processing models and techniques to process the unstructured data into a set of axioms or “facts.” The facts may be generated in the form of a sentence. That is, for a particular data object (i.e., a word document, PDF document, HTML document or other unstructured-type document), the extraction engine may generate a set of facts, where each fact includes a subject, predicate, and object. For instance, if a particular data object indicates that ABC Bank sold US government bonds on a particular date that were valued at $10 billion United States dollars (USD), a property extraction engine may parse the data object, and break the exemplary information down into several facts. A first fact may include: “ABC Bank” as a subject, “sold” as a predicate, and “US government bonds” as an object. Another fact generated by a property extraction engine may include “US government bonds” as a subject, “valued” as a predicate, and $10 billion USD” as an object.

An extraction engine may include machine learning (ML) models trained on NLP techniques and may process data objects as input to NLP ML models and receive facts as output of the models. NLP processes may use entity recognition techniques to capture relevant entities from the data and differentiate them across similar ones using entity disambiguation methods. That is, entity disambiguation techniques may determine correct associations of extracted entities with others in, e.g., a received datastore.

In accordance with aspects, an update checking engine may receive facts determined by an extraction engine and may perform processing to determine whether a knowledge graph may be updated with received facts or if the facts already exist within the knowledge graph. An update checking engine may receive facts and query a knowledge graph to determine whether the received facts are included in the knowledge graph. If a query returns one or more values in the received facts, an update checking engine may exclude or remove the value or values from the facts before further processing.

In accordance with aspects, a graph enrichment platform may include an ontology update engine. An ontology update engine may receive facts and determine a graph structure that the facts may be used to update. In some aspects, an organization may maintain different types of graph structures for different purposes. The techniques for graph enrichment and updating disclosed herein, may be used to update different types of graphs. Exemplary graphs that may be updated using techniques described herein include (but are not limited to) property graphs and Resource Description Framework (RDF) graphs.

A property graph database (sometimes referred to as a labeled property graph) stores properties in nodes and edges. Graph vertices are known as nodes. Each node in a property graph has a unique identifier and a set of key-value pairs. The key value pairs include properties that describe the node. Graph edges (connections between nodes) also have a unique identifier. Edges also include a type and a set of key-value pairs that describe the edge (i.e., the relationship between the nodes that the edge connects). Accordingly, nodes and edges include an internal data structure that describes the components.

An RDF graph (also known as a “triple store” or a “semantic graph database”), on the other hand, does not include an internal data structure within the graph components. A node in an RDF graph is either a subject node or an object node. Each subject node is a uniform resource identifier (URI) that uniquely identifies a resource (a real-world entity). Each object node is a literal value, and each edge denotes a type of relationship. Accordingly, and person represented in an RDF graph may include a subject node that is a URI and a “name” relationship edge that points to an object node that is the literal value (e.g., “Jane Doe”). Relationships in an RDF graph, however, are not uniquely identifiable, as they are in a labeled property graph.

In accordance with aspects, ontology update engine may recognize a new set of node types that is not currently present in a knowledge graph and may generate a set of nodes and connections based on received facts. Moreover, a property checking engine may be in operative communication with a registered properties repository and may retrieve properties related to nodes and assign retrieved properties to nodes. Additionally, a property checking engine may determine that an extracted fact or a value from an extracted fact may be applied as a property update to a node and/or an edge in a graph for a corresponding entity in a graph. A property checking engine may access a list of properties in a registered properties repository and compare a property received from an extracted fact to the list of properties retrieved from a registered properties repository. In the case where the received property is not found in the registered properties repository, then the received property may be generated as a new property for a corresponding graph entity and stored in the repository with an association to its corresponding graph entity or entities. The corresponding entity/entities in the graph may also be updated.

In an exemplary aspect, a fact such as: (Node: “ABC company”, {“Ownership”: “Public”}) may be extracted from an unstructured data source. A property checking engine may receive the determined property {“Ownership”: “Public”} and may determine that the property value is not included as associated with the node “ABC company” in a registered properties repository. Accordingly, the property checking engine may update the “ABC company” node in a graph database and further update a registered properties repository with the property and an association to the corresponding node. A property checking engine may use an ML model, algorithmic code, rules-based logic, and/or any other desired/suitable logic or artificial intelligence implementation to carry out the described property checks and updates.

In accordance with aspects, a link predictor may use ML models to predict relationships between newly generated nodes and existing nodes in the graph. Any suitable machine learning models may be used to predict relationships. In an exemplary aspect, a graph neural network model may be used to predict new relationships.

Before aspects push new and/or updated nodes to a knowledge graph, a conflict checking engine may execute and attempt to resolve any conflicts that are determined. If a conflict is determined that cannot be solved by the conflict engine, a human actor may be notified so that the conflict can be resolved and the update pushed to the knowledge graph.

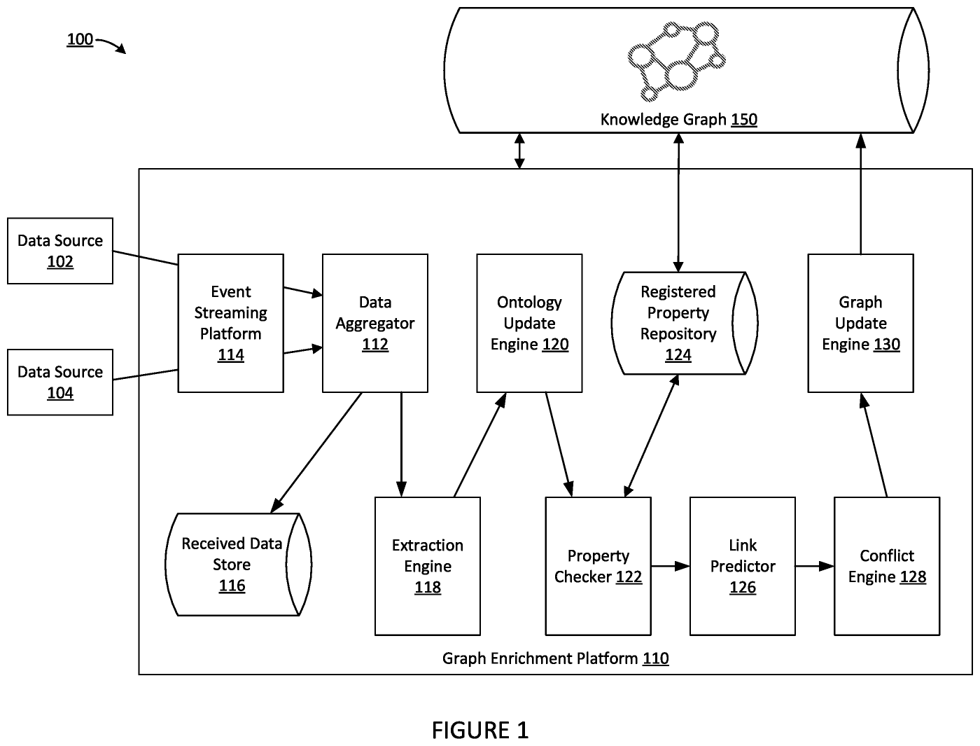

FIG. 1 is a system for knowledge graph enrichment using unstructured data, in accordance with aspects. System 100 includes graph enrichment platform 110. Graph enrichment platform 110 includes data aggregator 112, event streaming platform 114, received data store 116, extraction engine 118, ontology update engine 120, property checker 122, registered property graph repository 124, link predictor 126, conflict engine 128, and graph update engine 130. Graph enrichment platform 110 may be in operative communication with knowledge graph 150 and may push determined graph updates to knowledge graph 150.

In accordance with aspects, graph enrichment platform 110 may process received data objects to determine facts and may process determined facts for an update operation to knowledge graph 150. Graph enrichment platform 110 may receive one or more facts and perform a classification operation on relationships (edges) identified between determined nodes. Determined nodes and edges may be added to knowledge graph 150 in an update operation. In some aspects, a repository (e.g., a registered properties repository) of properties associated with various nodes and edges that exist within the current graph may be maintained for rapid reference by a property checker, and upon a determination that an identified property is not included in the repository, the repository may be updated with the identified property. In this way a property repository is continually updated with freshly identified properties for addition to a knowledge graph.

Data aggregator 112 may receive data from data source 102 and data source 104. Data source 102 and data source 104 may be any source of unstructured data that an organization captures. For instance, data source 102 may be a data source that is external to an organization while data source 104 may be an internal data source such as a business application provided by the organization.

In some aspects, data aggregator 112 may receive unstructured data from data source 102 and/or data source 104 via event streaming platform 114. Event streaming platform 114 may be a distributed event streaming platform and may provide a topic to which a data source (e.g., data source 102 and/or data source 104) may publish streaming data to via publisher API methods. Data published to a topic may be streaming data that is continuously produced by a data source. Data streamed to a topic may then be made available for ingestion via one or more subscribers to the provided topic. Accordingly, data source 102 and/or data source 104 may publish unstructured data to a topic provided by event streaming platform 114, and data aggregator 112 may ingest the unstructured data via consumer API methods that receive the streaming data from the provided topic.

In accordance with aspects, data aggregator 112 may persist received data to received data store 116. Received data store 116 may be any suitable data store. In some aspects, received data store 116 is a data lake configured to store and retrieve unstructured data in its native format as a data object.

Graph enrichment platform 110 may include extraction engine 118. Extraction engine 118 may receive data objects from data aggregator 112 and may perform property extraction techniques on the received data objects. Extraction engine 118 may include one or more natural language processing (NLP) machine learning (ML) models. Extraction engine 118 may receive unstructured data objects and may use the unstructured data objects as input to one or more NLP machine learning models. The NLP ML models may process the data objects and may generate facts from the data objects. Facts may be in the subject-predicate-object form as discussed in more detail, herein.

Graph enrichment platform 110 may perform an update check based on facts generated from extraction engine 118. That is, graph enrichment platform 110 may perform a query of a corresponding knowledge graph to determine if information included in a generated fact is already included in the graph or if the graph needs to be updated with the generated fact or with any sub-subcomponent of the generated fact. If the update check determines that some part of a generated fact needs to be added to the graph, then the generated fact may be transmitted to ontology update engine 120 to determine to what extent a corresponding knowledge graph's ontology will be updated.

In accordance with aspects, ontology update engine 120 may determine new nodes and edges that may be added to the graph during a graph update. For instance, ontology update engine 120 may determine that a subject, predicate and object of a received fact may be added to a knowledge graph and may determine a type of each new node (i.e., the subject and the object) and a label for the new edge (i.e., the relationship). In some aspects, an ontology update engine may determine ontology updates for only certain component parts of a fact. For instance, if the subject of a fact is already represented in the graph by a node, then the ontology update engine may determine that a corresponding object and predicate can be the basis of an ontology update and may prepare a graph update including a new graph object node with type and a new graph edge with a label from the predicate.

In accordance with aspects, an ontology update engine may transmit new nodes and edges to property checker 122, and property checker 122 may assign properties from registered property graph repository 124 to new graph components. A property checker may be in operative communication with a registered properties repository. A registered properties repository may store properties that are used in a corresponding knowledge graph. Registered property graph repository 124 may be in operative communication with knowledge graph 150 and may query the graph for various properties associated with nodes and edges included in knowledge graph 150. entities. In some aspects, property checker 122 may predict properties that may be associated with new node and edge components determined by ontology update engine 120. Property checker 122 may persist new properties to registered property graph repository 124 and may use new properties in future iterations for new graph components.

In accordance with aspects, graph updates including new nodes and edges and respective properties of the new nodes and edges may be processed by link predictor 126. Link predictor 126 may use machine learning models to predict edges from new nodes for a graph update to existing nodes in the graph. Exemplary ML models for link prediction may include graph neural network (GNN) models.

In accordance with aspects, a graph update including new nodes and edges, associated properties, and predicted edges from new nodes to existing nodes in a knowledge graph may be transmitted to conflict engine 128. Conflict engine 128 discovers any conflicts between the graph update and the current state of knowledge graph 150. In an exemplary conflict, revenue data for a particular company may be extracted as a first fact e.g., from a news article form source a first source. Thereafter, a second fact from a second article may be extracted, where the second fact includes different revenue data (e.g., a different revenue amount) for the same company. Such a scenario may be flagged as a conflict in conflict engine 128, since the two data points provide conflicting values for a single data field. Conflict engine 128 may attempt to rectify any determined conflict (such as the exemplary conflict described above) programmatically. If a determined conflict cannot be remedied by conflict engine 128, a human actor may be notified, and the conflict may be presented to the human actor prior to pushing the graph update to knowledge graph 150.

If no conflicts are detected, or once all conflicts have been resolved, graph update engine 130 may receive the update and push the update, including new nodes and edges and corresponding properties, and any new edges from new nodes to existing nodes, to knowledge graph 150.

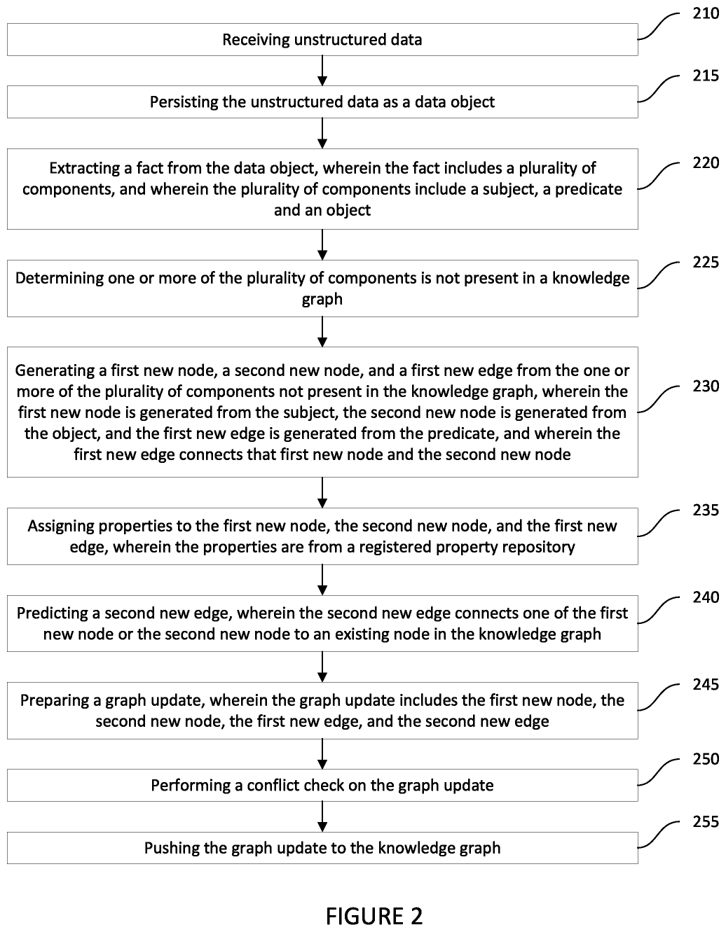

FIG. 2 is a logical flow for knowledge graph enrichment using unstructured data, in accordance with aspects.

Step 210 includes receiving unstructured data from a data source.

Step 215 includes persisting the unstructured data as a data object to a data store.

Step 220 includes extracting a fact from the data object, wherein the fact includes a plurality of components, where the plurality of components include a subject, a predicate and an object.

Step 225 includes determining one or more of the plurality of components is not present in a knowledge graph.

Step 230 includes generating a first new node, a second new node, and a first new edge from the one or more of the plurality of components not present in the knowledge graph. The first new node may be generated from the subject, the second new node may be generated from the object, and the first new edge may be generated from the predicate. The first new edge may connect the first new node and the second new node. In some aspects, an existing node or an existing edge may be updated with a determined property (e.g., by a property checking engine as described further herein). In some aspects, properties may be updated with a

Step 235 includes assigning properties to the first new node, the second new node, and the first new edge. The properties may be from a registered property repository that extracts registered properties from a knowledge graph.

Step 240 includes predicting a second new edge, where the second new edge connects one of the first new node or the second new node to an existing node in the knowledge graph. In some aspects, multiple new edges may be generated and may not necessarily connect to entities included in a relevant tuple. For instance, if a risk level of one bank increases, indicating a new risk edge/property update inferred by a link predictor, then an updated risk edge/property may be updated for various other bank entities in a graph database.

Step 245 includes preparing a graph update. The graph update may include the first new node, the second new node, the first new edge, and the second new edge, or may include any combination thereof.

Step 250 includes performing a conflict check on the graph update.

Step 255 includes pushing the graph update to the knowledge graph.

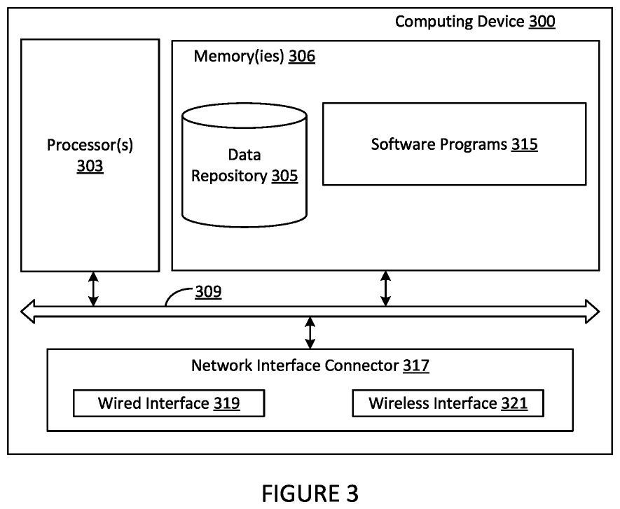

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such as a data aggregator, an event streaming platform, an extraction engine, an ontology update engine, various database engines and database servers, other components of a graph enrichment platform, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving unstructured data;
persisting the unstructured data as a data object;
extracting a fact from the data object, wherein the fact includes a plurality of components, and wherein the plurality of components include a subject, a predicate and an object;
determining one or more of the plurality of components is not present in a knowledge graph;
generating a first new node, a second new node, and a first new edge from the one or more of the plurality of components not present in the knowledge graph,
assigning properties to the first new node, the second new node, and the first new edge;
predicting a second new edge, wherein the second new edge connects one of the first new node or the second new node to an existing node in the knowledge graph;
preparing a graph update, wherein the graph update includes the first new node, the second new node, the first new edge, and the second new edge;
performing a conflict check on the graph update; and
pushing the graph update to the knowledge graph.

2. The method of claim 1, wherein the first new node is generated from the subject, the second new node is generated from the object, and the first new edge is generated from the predicate.

3. The method of claim 2, wherein the first new edge connects that first new node and the second new node.

4. The method of claim 1, wherein the properties are from a registered property repository.

5. The method of claim 1, wherein the unstructured data is received as a data stream from an event streaming platform.

6. The method of claim 1, wherein the knowledge graph is a labelled property graph.

7. The method of claim 1, wherein the knowledge graph is a Resource Description Framework (RDF) graph.

8. A system comprising at least one computer including a processor and a memory, wherein the at least one computer is configured to:
receive unstructured data;
persist the unstructured data as a data object;
extract a fact from the data object, wherein the fact includes a plurality of components, and wherein the plurality of components include a subject, a predicate and an object;
determine one or more of the plurality of components is not present in a knowledge graph;
generate a first new node, a second new node, and a first new edge from the one or more of the plurality of components not present in the knowledge graph,
assign properties to the first new node, the second new node, and the first new edge;
predict a second new edge, wherein the second new edge connects one of the first new node or the second new node to an existing node in the knowledge graph;
prepare a graph update, wherein the graph update includes the first new node, the second new node, the first new edge, and the second new edge;
perform a conflict check on the graph update; and
push the graph update to the knowledge graph.

9. The system of claim 8, wherein the first new node is generated from the subject, the second new node is generated from the object, and the first new edge is generated from the predicate.

10. The system of claim 9, wherein the first new edge connects that first new node and the second new node.

11. The system of claim 8, wherein the properties are from a registered property repository.

12. The system of claim 8, wherein the unstructured data is received as a data stream from an event streaming platform.

13. The system of claim 8, wherein the knowledge graph is a labelled property graph.

14. The system of claim 8, wherein the knowledge graph is a Resource Description Framework (RDF) graph.

15. A non-transitory computer readable storage medium, including instructions stored thereon, which instructions, when read and executed by one or more computer processors, cause the one or more computer processors to perform steps comprising:
receiving unstructured data;
persisting the unstructured data as a data object;
extracting a fact from the data object, wherein the fact includes a plurality of components, and wherein the plurality of components include a subject, a predicate and an object;
determining one or more of the plurality of components is not present in a knowledge graph;
generating a first new node, a second new node, and a first new edge from the one or more of the plurality of components not present in the knowledge graph,
assigning properties to the first new node, the second new node, and the first new edge;
predicting a second new edge, wherein the second new edge connects one of the first new node or the second new node to an existing node in the knowledge graph;
preparing a graph update, wherein the graph update includes the first new node, the second new node, the first new edge, and the second new edge;
performing a conflict check on the graph update; and
pushing the graph update to the knowledge graph.

16. The non-transitory computer readable storage medium of claim 15, wherein the first new node is generated from the subject, the second new node is generated from the object, and the first new edge is generated from the predicate.

17. The non-transitory computer readable storage medium of claim 16, wherein the first new edge connects that first new node and the second new node.

18. The non-transitory computer readable storage medium of claim 15, wherein the properties are from a registered property repository.

19. The non-transitory computer readable storage medium of claim 15, wherein the unstructured data is received as a data stream from an event streaming platform.

20. The non-transitory computer readable storage medium of claim 15, wherein the knowledge graph is a labelled property graph.
